(19) United States
(12) Patent Application Publication
(10) Pub. No.: US 2016/0011363 A1
(43) Pub. Date: Jan. 14, 2016

(54) LIGHTING DEVICE

(71) Applicant: Oh Young KWON, Gyeongsangnam-do (KR)

(72) Inventor: Oh Young KWON, Gyeongsangnam-do (KR)

(21) Appl. No.: 14/397,082

(22) PCT Filed: Nov. 29, 2013
(86) PCT No.: PCT/KR2013/011021

§ 371 Date: Oct. 24, 2014

(30) Foreign Application Priority Data
Jul. 5, 2013 (KR) 10-2013-0079037

(51) Int. Cl. F21V 8/00; F21V 21/096

(52) U.S. Cl. CPC G02B 6/0073; G02B 6/005; G02B 6/0091; F21V 21/096

(57) ABSTRACT

Provided is a lighting device. The lighting device includes a light emitting diode (LED) mounted on a substrate, a light transmitting member disposed above an illumination surface with a minimal gap from the LED, and a housing in which the substrate, the light transmitting member, and a battery assembly are assembled, wherein the light transmitting member is formed of a transparent material to transmit light from a light source onto the illumination surface, the light transmitting member has a generally thin rectangular shape formed by two mutually-facing lateral surfaces, two mutually-facing end surfaces, an upper major surface, and a lower major surface, one or more of the end surfaces being coated with a reflective material, and one or more of the upper and lower major surfaces having negative curvatures.

### CROSS-REFERENCE TO RELATED APPLICATIONS

This application is the National Stage of International Application No. PCT/KR2013/011021 having International filing date 29 Nov. 2013, which designated the United States of America, and which claims priority from, and the benefit of, Korean Application No. 10-2013-0079037, filed on 5 Jul. 2013, the disclosures of which are incorporated herein by reference in their entireties.

### FIELD

The presently disclosed embodiment relates to a lighting device, and more particularly, to a lighting device including: alight emitting diode (LED) mounted on a substrate; a light transmitting member disposed above an illumination surface with a minimal gap from the LED; and a housing in which the substrate, the light transmitting member, and a battery assembly are assembled, wherein the light transmitting member is formed of a transparent material to transmit light from a light source onto the illumination surface, and the light transmitting member has a generally thin rectangular shape formed by two mutually-facing lateral surfaces, two mutually-facing end surfaces, an upper major surface, and a lower major surface, one or more of the end surfaces being coated with a reflective material, and one or more of the upper and lower major surfaces having negative curvatures.

### BACKGROUND

Portable lighting devices are well known devices having various application forms. Such a portable lighting device may be used after being attached or clamped to paper or a portion of a book. A light source may be disposed at a position spaced apart from an object to be read and may emit light onto the object.

In general, such a portable lighting device is configured to emit light onto only a portion to be read. Therefore, although portable lighting devices function properly as described above, there may be illumination problems or inconvenience in use. It may be inconvenient to attach such a portable lighting device to a book or magazine even though the portable lighting device is small and light.

Other types of devices basically include a light source and an illuminating body disposed above an illumination surface. The illuminating body includes a light transmitting material for transmitting light emitted from the light source onto the illumination surface. In general, the illuminating body is formed of a transparent material and has a wedge-shape tapered from a wide edge so as to transmit light onto a page having an illumination surface to be illuminated.

Such a wedge-shaped illuminating body has the following disadvantages.
Since the wedge-type illuminating body is relatively heavy, most of the weight of a portable lighting device is the weight of a light transmitting member.
Since a thin end portion of the light transmitting member is too bright, surplus light spots causing inconvenience in reading are formed, and there is a considerable amount of light leakage.
A tapered angle between two major surfaces of a wedge-shaped light transmitting member leads to optical distortion on an illumination surface.

FIG. 1 illustrates a related-art technique with respect to an illumination surface and an illuminating body including a light source. In general, the illuminating body is formed of an acrylic material or another material, and when the illuminating body is exposed to the light source disposed along an end of the illuminating body or at a position close to the end of the illuminating body, the illuminating body distributes light.

A tapered wedge-shaped body having a flat surface is controlled to illuminate a work surface close to a major surface in a continuous and uniform manner.

A surface mount device (SMD) type LED may be used as a light source for a very thin light transmitting member. However, it is difficult to properly illuminate a page of a book using the very thin wedge-shaped light transmitting member.

As shown in FIG. 2, a thin flat rectangular light transmitting member is advantageous in that the thin flat rectangular light transmitting member is lighter than a wedge-shaped light transmitting member. However, the thin flat rectangular light transmitting member having parallel major surfaces does not provide uniform light in a lengthwise direction thereof when compared to light transmitting members having tapered or wedge-shaped bodies.

Thin rectangular light transmitting members have been improved in terms of the uniformity and intensity of light by coating an end surface thereof with a coating layer.

A thin rectangular light transmitting member, having a reflection part formed on an outer end surface thereof by a coating method, may illuminate a page by receiving light from an LED, transmitting the light through an illuminating body, and reflecting the light at the outer end surface. The light transmitting member has equal reflection and entrance regions. Owing to this, reflected light beams may contribute to overall illumination. The reflection part of the rectangular light transmitting member improves luminosity by 40% to 50% and improves the uniformity of light. The intensity and uniformity of light are determined by the thickness, length, and surface flatness of the rectangular light transmitting member.

An entrance surface of the light transmitting member may also be coated with a reflective material (an optical entrance surface between the light transmitting member and a light source is excluded). In the above example, the luminosity of light may be improved by 10% to 12% in addition to the effect of reflection at the outer end surface.

However, if the angle of the light source is smaller than a reflection angle generally required for uniform illumination, the reflection part is ineffective. A coating on the thinnest portion of the end surface is effective only in preventing leakage of light from the end surface. Since the end surface is small, light delivered back to the light transmitting member from the end surface has no significant effect.

### SUMMARY

To solve the above-mentioned problems, the presently disclosed embodiment provides a lighting device including: a light emitting diode (LED) mounted on a substrate; a light transmitting member disposed above an illumination surface with a minimal gap from the LED; and a housing in which the substrate, the light transmitting member, and a battery assembly are assembled, wherein the light transmitting member is formed of a transparent material to transmit light from a light source onto the illumination surface, the light transmitting member has a generally thin rectangular shape formed by two mutually-facing lateral surfaces, two mutually-facing end surfaces, an upper major surface, and a lower major surface, one or more of the end surfaces being coated with a reflective material, and one or more of the upper and lower major surfaces having negative curvatures.

According to an aspect of the presently disclosed embodiment, there is provided a lighting device including: a light emitting diode (LED) mounted on a substrate; a light transmitting member disposed above an illumination surface with a minimal gap from the LED; and a housing in which the substrate, the light transmitting member, and a battery assembly are assembled, wherein the light transmitting member is formed of a transparent material to transmit light from a light source onto the illumination surface, the light transmitting member has a generally thin rectangular shape formed by two mutually-facing lateral surfaces, two mutually-facing end surfaces, an upper major surface, and a lower major surface, one or more of the end surfaces being coated with a reflective material, and one or more of the upper and lower major surfaces having negative curvatures, and the light transmitting member is disposed along an optical path of the LED to refract light emitted from the LED onto the illumination surface.

Preferably, the light transmitting member may be bent to enhance illumination of the illumination surface.

Preferably, the two end surfaces may not be parallel.

Preferably, the upper major surface may be coupled with a Fresnel lens for optical magnification.

Preferably, a transparent film may be attached to the upper major surface.

Preferably, the light transmitting member may include a pattern formed by a plurality of fine hemispherical recesses formed in at least a surface portion thereof.

Preferably, the housing may include a jaw bent in a reverse L-shape, and an end of the reverse L-shape may be rounded.

Preferably, a magnetic member may be disposed on a side of the light transmitting member, and an attachment part corresponding to the magnetic member and magnetically attractable to the magnetic member may be disposed on at least a side of an upper end of the housing.

Preferably, the housing may have a side opened in a C-shape, a printed circuit board (PCB), the LED mounted on the PCB, and reflection mirrors reflecting light emitted from the LED may be disposed in the housing, the reflection mirrors may be disposed at upper and lower sides in the housing with an angle between the reflection mirrors, and an opened side of the reflection mirrors may face the opened side of the housing to direct light emitted from the LED to the opened side of the housing.

Preferably, the lighting device may further include a fixing clip gripping a side of an illumination target object, wherein a first magnetic member may be disposed on an upper surface of the fixing clip, and a second magnetic member corresponding to the first magnetic member and magnetically attractable to the first magnetic member may be disposed on a lower surface of the housing.

The fixing clip may include an electricity connection terminal to connect an internal power source of the illumination target object to the PCB and the LED disposed in the housing, and the LED disposed in the housing may be configured to use the internal power source of the illumination target object as a power source.

According to the presently disclosed embodiment, since a lighting device illuminates an object by using a thin light transmitting member, the portability of the lighting device may be improved. In addition, since the lighting device can be placed on a page, the lighting device may be used more conveniently.

In addition, since the lighting device provides light having improved intensity and uniformity, a user may use the lighting device more conveniently.

Furthermore, since the light transmitting member includes a pattern, uniform illumination may be possible.

Furthermore, owing to the structure of a housing of the lighting device, the housing may easily be placed on an object to be illuminated, and thus a user may conveniently use the lighting device.

Furthermore, owing to a connection using magnetic members, a fixing clip, the housing, and the light transmitting member may be easily attached and detached.

Furthermore, the lighting device of the present invention may be powered by an internal power source of an illumination target object such as an e-book terminal.

### BRIEF DESCRIPTION OF THE DRAWINGS

FIG. 1 is a side view illustrating an illuminating body of the related art.

FIG. 2 is a side view illustrating a lighting device including a rectangular light transmitting member having an end reflection part facing the light transmitting member.

FIG. 3 is a side view illustrating a lighting device including a light transmitting member, the light transmitting member having a concave lower major surface and an end reflection part facing the light transmitting member.

FIG. 4 is a side view illustrating a lighting device including a light transmitting member, the light transmitting member having a convex upper major surface and an end reflection part facing the light transmitting member.

FIG. 5 is a side view illustrating a lighting device including a light transmitting member, the light transmitting member having two end reflection parts facing the light transmitting member, a concave lower major surface, and a convex upper major surface.

FIG. 6 is a perspective view illustrating a lighting device including a light transmitting member, the light transmitting member having a concave lower major surface, a convex upper major surface, and an end reflection part facing the light transmitting member.

FIG. 7 is a perspective view illustrating a light transmitting member having two concave major surfaces.

FIG. 8 is a side view illustrating a lighting device including a Fresnel lens.

FIGS. 9A to 9C are side views illustrating lighting devices including light transmitting members having flat and concave lower major surfaces.

FIGS. 10A and 10B are side views illustrating lighting devices including light transmitting members having flat and concave upper major surfaces.

FIG. 11 is a view illustrating a light transmitting member of a lighting device according to an aspect of the presently disclosed embodiment.

FIG. 12 is a view illustrating a lighting device according to an aspect of the presently disclosed embodiment.

FIG. 13 is a view illustrating a light transmitting member of a lighting device according to an aspect of the presently disclosed embodiment.

FIG. 14 is a view illustrating an inner structure of a housing of a lighting device according to an aspect of the presently disclosed embodiment.

FIG. 15 is a view illustrating a fixing clip of a lighting device according to an aspect of the presently disclosed embodiment.

FIG. 16 is a view illustrating a light transmitting member of a lighting device according to an aspect of the presently disclosed embodiment.

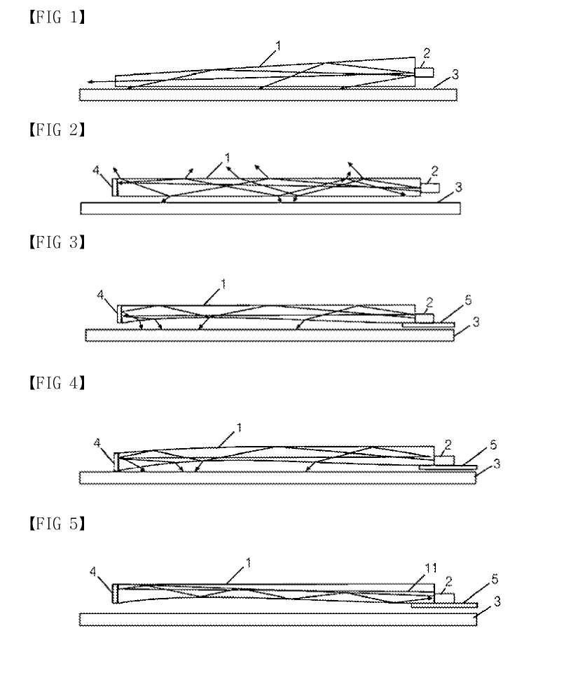

### DETAILED DESCRIPTION

According to the presently disclosed embodiment, a lighting device includes: a light emitting diode (LED) mounted on a substrate; a light transmitting member disposed above an illumination surface with a minimal gap from the LED; and a housing in which the substrate, the light transmitting member, and a battery assembly are assembled, wherein the light transmitting member is formed of a transparent material to transmit light from a light source onto the illumination surface, the light transmitting member has a thin rectangular shape formed by two mutually-facing lateral surfaces, two mutually-facing end surfaces, an upper major surface, and a lower major surface, one or more of the end surfaces being coated with a reflective material, and one or more of the upper and lower major surfaces having negative curvatures, and the light transmitting member is disposed along an optical path of the LED to refract light emitted from the LED to the illumination surface.

Hereinafter, preferable aspects of the present disclosure will be described with reference to the accompanying drawings. However, the aspects are not intended to limit the spirit and scope of the presently disclosed embodiment.

Advantages and features of the presently disclosed embodiment, and implementation methods thereof will be clarified through the following descriptions given with reference to the accompanying drawings. The presently disclosed embodiment may, however, be embodied in different forms and should not be construed as being limited to the aspects set forth herein. Rather, these aspects are provided so that this disclosure will be thorough and complete, and will fully convey the scope of the presently disclosed embodiment to those of ordinary skill in the art. Therefore, the scope and spirit of the presently disclosed embodiment should be defined by the following claims. Throughout the present disclosure, like reference numerals denote like elements.

Spatially relative terms, such as “below,” “beneath,” “lower,” “above,” “upper,” and the like, may be used herein for ease of description to describe one member or element's relationship to another member(s) or element(s) as illustrated in the drawings. It will be understood that the spatially relative terms are intended to encompass different orientations of the device in use or operation in addition to the orientation depicted in the drawings. For example, if the device in the drawings is turned over, members or elements described as “upper” members or elements would then be described as “lower” members or elements. Members or elements may be otherwise oriented, and then the spatially relative terms may be interpreted accordingly.

In the following description, the technical terms are used only for explaining exemplary aspects, and not for purposes of limitation. The terms of a singular form may include plural forms unless specifically mentioned. The meaning of ‘comprises’ and/or ‘comprising’ specifies an element, a step, a process, an operation, and/or a member but does not exclude other elements, steps, processes, operations, and/or members.

Unless otherwise defined, all terms (including technical and scientific terms) used herein have the same meaning as commonly understood by those of ordinary skill in the art to which this invention belongs. It will be further understood that terms, such as those defined in commonly used dictionaries, will not be interpreted in an idealized or overly formal sense unless expressly so defined herein.

An advanced device including a thin light transmitting member 1 is illustrated in FIG. 3 according to an aspect.

The light transmitting member 1 is formed of a transparent material to transmit light emitted from a light source to an illumination surface 3. On the whole, the light transmitting member 1 has a thin rectangular plate shape formed by two mutually-facing parallel lateral surfaces, two mutually-facing end surfaces, and two major surfaces. At least one of the end surfaces is coated with a reflective material, and at least one of the major surfaces has a negative curvature. That is, the light transmitting member 1 forms in basically thin rectangular-shaped body.

The two end surfaces may be an entrance surface and a reflection surface, respectively. The entrance surface is a surface on which light is incident, and the reflection surface is a surface facing the entrance surface and formed of a material having a certain degree of reflectivity. A reflection part 4 may be disposed on the reflection surface, and the reflection part 4 may be coated with a reflective material or coupled with a particular member.

The major surfaces are two surfaces forming the area of the thin rectangular plate shape. The major surfaces include an upper major surface and a lower major surface. The lateral surfaces correspond to the end surfaces. When the light transmitting member 1 having a rectangular plate shape is viewed from above, the lateral surfaces form the upper side and the lower side of the light transmitting member 1.

In addition, the illumination surface 3 refers to an object to be illuminated using a lighting device according to the presently disclosed embodiment. For example, the illumination surface 3 may be a page of a book.

The light transmitting member 1 may be formed by stacking two thin members. That is, as shown in FIG. 3, the light transmitting member 1 may be formed by stacking rectangular plate shaped members, and interfaces between the stacked members may function as total reflection surfaces.

The lower major surface of the light transmitting member 1 may be sloped from the entrance surface and the reflection surface. In the above, the expression “sloped” is used to denote that the lower major surface is sloped at an angle from a bottom surface, and may encompass the case in which the lower major surface is sloped twice to form a curved surface as described later.

Light emitting diodes (LEDs) 2 are disposed on a printed circuit board (PCB) 5 at positions adjacent to the entrance surface.

To illuminate the illumination surface 3, the light transmitting member 1 transmits light to the illumination surface 3 by receiving light from the LEDs 2, transmitting the light through an illuminating body, and reflecting the light to a discharge surface. The light transmitting member 1 has equal reflection and entrance regions. Slopes of the major surfaces increase the intensity of light in a direction from an end of the entrance surface to the reflection surface. The thinnest portion of the light transmitting member 1 is not extremely thin. For example, the thinnest portion of the light transmitting member 1 may be thicker than half the thickness of the light transmitting member 1. Preferably, only the lower major surface may be sloped to reduce dark spots on the illumination surface 3.

The end of the entrance surface has a slope angle different from that of a reflection end. A sloped surface is curved to form a smooth connection at the thinnest portion of the light transmitting member 1. That is, a slope starting from the end of the entrance surface and a slope starting from the reflection end are connected at the thinnest portion of the light transmitting member 1 in a curved manner without an angulated part. Slope angles determine the maximum intensity and uniformity of illumination.

A double-sloped surface having a smooth connection at a thin portion of the light transmitting member 1 forms a negatively curved surface.

A gap formed between the light transmitting member 1 and the illumination surface 3 removes dark spots from a view surface because of scattering of light reflected from a view region to the light transmitting member 1.

The reflection part 4 of the light transmitting member 1 may not be parallel with the entrance surface and may be configured to increase a refractive index.

As shown in FIG. 4, in another aspect of an illuminating body, a bent light transmitting member 1 may be provided. To illuminate a page, the light transmitting member 1 transmits light to the page by receiving light from LEDs, transmitting the light through an illuminating body, and reflecting the light to a discharge surface. Bending of the light transmitting member 1 has the effects of increasing a gap between the illuminating body and an illumination surface 3, the number of non-parallel light rays, and refraction and diffusion of light. The air gap between light transmitting member 1 and illuminating surface 3 eliminates the dark spots on the surface when depleted skew rays refracted back in the light transmitting member 1 with the angle lesser then total internal reflection angle. That is, according to the structure of the light transmitting member 1 of the aspect, dark spots may be removed to improve user convenience.

Another aspect is illustrated in FIG. 5.

To illuminate a page, a light transmitting member 1 transmits light to the page by receiving light from LEDs, transmitting the light through an illuminating body, and reflecting the light to a discharge surface. A margin area of an upper major surface 11 is sloped from a reflection part 4 to an entrance surface. That is, as shown in FIG. 5, a member may be disposed on the upper major surface 11, and an upward slope may be formed in a direction from the reflection part 4 to the entrance surface. The margin area may form a positive curvature. That is, the upper major surface 11 may be convex. The upper major surface 11 which is convex may improve illumination of a peripheral region of the entrance surface.

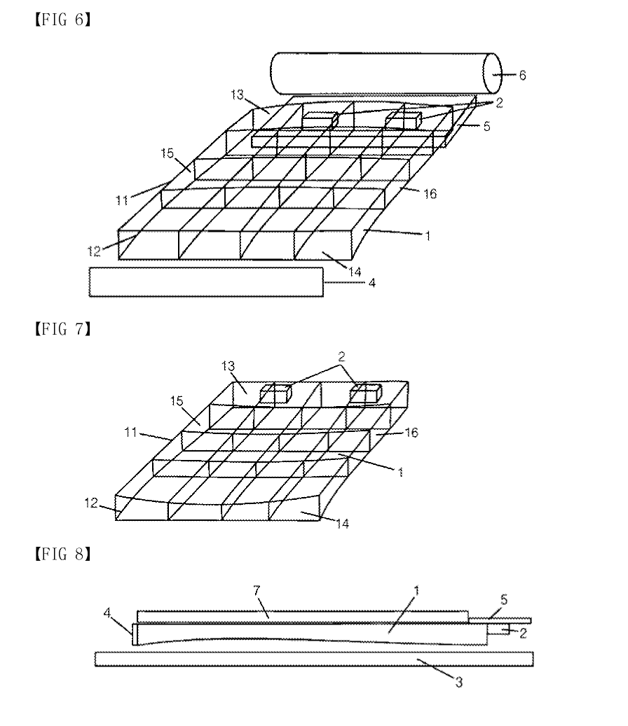

FIG. 6 is a perspective view illustrating an aspect of the presently disclosed embodiment.

To illuminate a page, a light transmitting member 1 having upper and lower major surfaces 11 and 12 transmits light to the page by receiving light from LEDs 3 through an end of an entrance surface 13, transmitting the light through an illuminating body, and reflecting the light by a reflection part 4. The light transmitting member 1 may have a thin rectangular shape, and lateral surfaces 15 and 16 may be formed on both sides thereof. The lower major surface 12 is double-sloped from the entrance surface 13 and a reflection surface 14, and slopes of the lower major surface 12 are smoothly connected at a thin portion of the light transmitting member 1 to form a concave curvature.

The upper major surface 11 is double-sloped from the reflection surface 14 to the entrance surface 13 to form a concave curvature. The LEDs 3 which are surface mount type LEDs are mounted on a PCB 5 having an electric driving circuit. The PCB 5 including the LEDs 2 is coupled to the lower major surface 12 of the light transmitting member 1 by using screws or any other bonding method so as to impart superior optical characteristics to the entrance surface 13 formed between the light transmitting member 1 and flat surfaces of the LEDs 3. All parts of a lighting device are assembled in a housing 5 including a substrate, the light transmitting member 1, and a battery assembly.

A surface map of the light transmitting member 1 may be illustrated as a wedge-type curved surface mesh. In general, a tapering angle of a surface curved from the reflection surface 14 and the entrance surface 13 has different values in length, left, and right directions. The curvature of the surface is adjusted according to the uniformity and intensity of light. The light transmitting member 1, the PCB, and the housing 6 are disposed in such a manner that an air gap may be formed between the light transmitting member 1 and an illumination surface to remove dark spots of optical structures from the illumination surface.

The housing 6 may be shaped such that the lighting device may easily be fixed and slide with respect to the illumination surface.

FIG. 7 illustrates another aspect.

A light transmitting member 1 illuminates an illumination surface by transmitting light coming from LEDs 2 to the illumination surface. Upper and lower major surfaces 11 and 12 have concave shapes. According to the current aspect, the uniformity of illumination may be improved at a center region of a field of vision.

The upper major surface 11 having a positive curvature may function as a lens having a particular focal length, and a lighting device may illuminate the illumination surface in an improved manner. Another aspect for improvingly illuminating an illumination surface is illustrated in FIG. 8. A light transmitting member 1 illuminates a page by receiving light from LEDs 2 mounted on a PCB, transmitting the light through an illuminating body, and reflecting the light to a discharge surface. A flat Fresnel lens 7 is disposed above the light transmitting member 1, and each transparent body independently refracts light. A thin transparent film may be used instead of the Fresnel lens 7. According to the current aspect, the light transmitting member 1 may be prevented from being scratched.

A lighting device including the light transmitting member 1 for providing illumination and a field of vision may poorly transmit light to an illumination surface if diffuse reflection occurs due to the roughness of major surfaces of the light transmitting member 1.

However, according to the current aspect, the effect of scratches may be removed, and thus the above-mentioned problems may be solved.

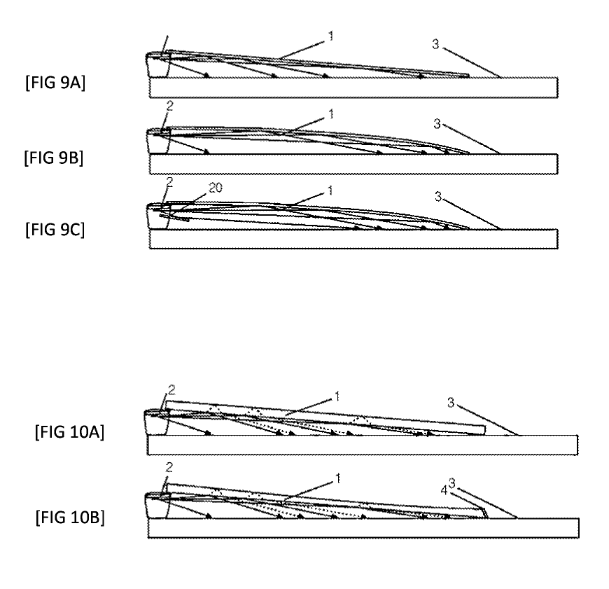

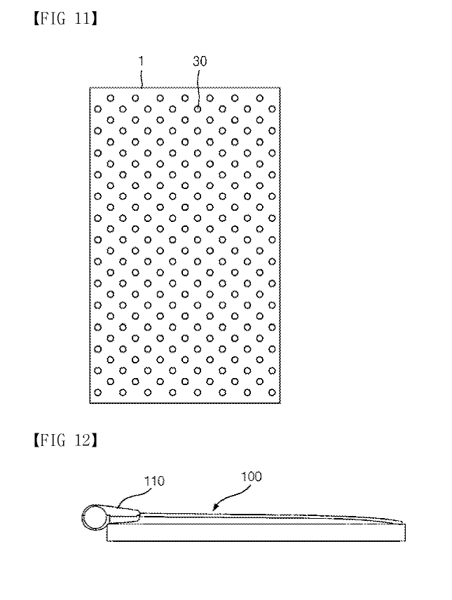

FIGS. 9A to 9C illustrate other aspects of the presently disclosed embodiment.

Referring to FIG. 9A, a flat light transmitting member 1 is disposed along an optical path of light emitted from LEDs mounted on a PCB to refract the light to an illumination surface 3 by reflection at a sloped lower major surface thereof. Unlike a lighting device in which light is incident on an entrance surface of a light transmitting member 1, according to the current aspect, a distant end portion is darker than a close portion, and the uniformity of light is low.

Referring to FIG. 9B, a bent light transmitting member 1 is disposed above a PCB on which LEDs are mounted, so as to refract light to an illumination surface 3 by reflection at a sloped lower major surface thereof. Owing to a negative curvature of the lower major surface, more light beams are reflected to a distant end portion of the illumination surface 3, and thus the uniformity of light increases.

Referring to FIG. 9C, a light transmitting member 1 is coupled to a housing including a mirror 20 having a negatively curved surface and a PCB on which LEDs 2 are mounted, so as to narrower an optical path when viewed from side.

A lighting device is disposed above an e-book reader. In the current aspect, the uniformity of illumination is improved at end portions of a field of vision. According to this aspect, illumination is less affected by surface scratches of the light transmitting member 1.

FIGS. 10A and 10B illustrate other aspects.

Referring to FIG. 10A, a flat light transmitting member 1 is disposed above light emitted from LEDs 2 mounted on a PCB to transmit the light to an illumination surface 3 by reflection (denoted by solid lines) at a lower major surface thereof and reflection (denoted by dotted lines) at an upper major surface thereof. When the current aspect is compared with a lighting device in which light is incident on an entrance surface of a light transmitting member 1, the uniformity of light is relatively low, and a distant end portion of the illumination surface 3 is darker than a close portion of the illumination surface 3.

Referring to FIG. 10B, a light transmitting member 1 having a negatively curved upper major surface is disposed above light emitted from LEDs 2 mounted on a PCB so as to transmit the light to an illumination surface 3 by reflection (denoted by solid lines) at the lower major surface and reflection (denoted by dotted lines) at an upper major surface. Owing to the negatively curved upper major surface, more light is reflected to a distant end portion of the illumination surface 3, and thus the uniformity of light increases. A reflection part 4 disposed on an end surface of the light transmitting member 1 additionally illuminates the distant end portion of the illumination surface 3, and thus the uniformity of light is additionally improved. If both the upper and lower major surfaces of the light transmitting member 1 have negative curvatures, the uniformity of light may be further improved. In this case, the upper and lower major surfaces of the light transmitting member 1 may have different curvatures.

According to an aspect of the presently disclosed embodiment, some e-book readers include electric terminals connected to an internal battery. Therefore, a lighting device may be powered from an internal battery of an e-book reader through a cable, and in this case, the size of a housing may be reduced.

FIGS. 11 and 16 illustrate a surface of a light transmitting member 1 according to an aspect of the presently disclosed embodiment.

Referring to FIGS. 11 and 16, the light transmitting member 1 of the current aspect may include a predetermined pattern 30.

As shown in FIG. 16, the pattern 30 may be formed by recessing at least some portions of the surface of the light transmitting member 1 in a fine hemispherical shape, and the density of hemispheres of the pattern 30 may be determined by a constant number of hemispheres formed in a constant area. However, the pattern 30 is not limited thereto.

Owing to the pattern 30 formed on the surface of the light transmitting member 1, light emitted from a light source is repeatedly refracted or scattered each time the light is incident on the pattern 30 and is then cast on the surface of an illumination target object. Therefore, uniform illumination may be possible.

FIG. 12 illustrates an aspect.

FIG. 12 is a view illustrating a placed state of a lighting device 100 according to an aspect of the presently disclosed embodiment.

Referring to FIG. 12, the lighting device 100 of the aspect of the presently disclosed embodiment may be placed on an upper end of an object to be illuminated, such as a paper book, in a state in which a housing 110 of the lighting device 100 is placed across an edge of the object.

That is, as shown in FIG. 12, the housing 110 includes a jaw 112 bent in a reverse L-shape so as to be placed across the edge of the object. A lower end of the reverse L-shape is rounded, and thus the lighting device 100 may be easily moved on a page of the object.

FIG. 13 is a view illustrating a light transmitting member 120 of a lighting device according to an aspect of the presently disclosed invention.

Referring to FIG. 13, in the current aspect, the light transmitting member 120 and a housing of the lighting device may include magnetic members 122 disposed in at least sides thereof.

That is, as shown in FIG. 13, the magnetic members 122 such as magnets may be disposed in an outer region of a side of the light transmitting member 120. The magnets may be fixed to the light transmitting member 120 by any method.

Attachment parts corresponding to the magnets maybe formed on a side of the housing. The attachment parts may be formed of a material magnetically attractable to the magnetic members 122 when the magnetic members 122 are approached. For example, the attachment parts may have a plate shape formed of steel.

As described above, the light transmitting member 120 includes the magnetic members 122, and the housing includes the attachment parts. Therefore, the light transmitting member 120 and the housing may easily be attached to and detached from each other.

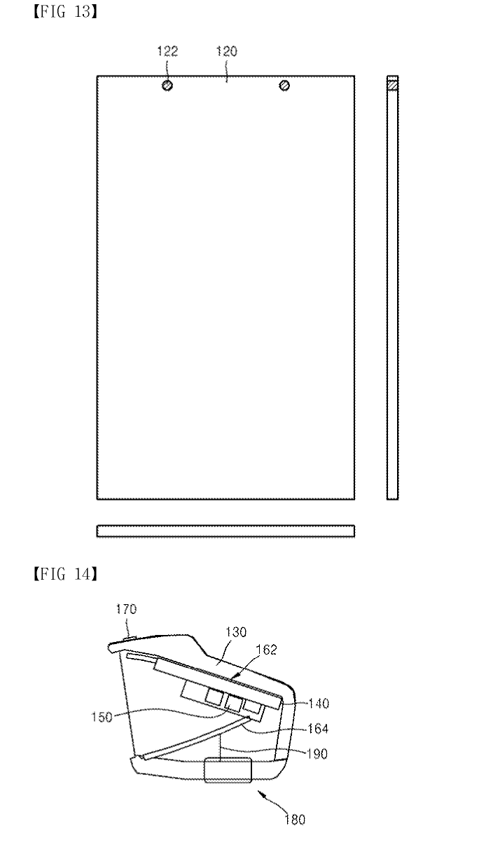

FIG. 14 is a view illustrating an inner structure of a housing 130 of a lighting device according to an aspect of the presently disclosed invention.

Referring to FIG. 14, the lighting device of the aspect of the presently disclosed embodiment may include the housing 130 having an opened side, a PCB 140 disposed in the housing 130, LEDs 150 mounted on the PCB 140, and reflection mirrors 160 reflecting light emitted from the LEDs 150. The reflection mirrors 160 may be disposed at upper and lower sides in the housing 130 at an angle therebetween, and an opened side of the reflection mirrors 160 may face the opened side of the housing 130.

A side of the housing 130 may be opened. Therefore, the housing 130 may have a C-shaped sectional shape.

The PCB 140, the LEDs 150 mounted on the PCB 140, and the reflection mirrors 160 may be disposed in the housing 130.

Light emitted from the LEDs 150 may be reflected by the reflection mirrors 160. The reflection mirrors 160 may be disposed at upper and lower sides in the housing 130 at an angle therebetween, and an opened side of the reflection mirrors 160 may face the opened side of the housing 130. That is, the reflection mirrors 160 may include an upper reflection mirror 162 and a lower reflection mirror 164 that are disposed at upper and lower sides in the housing 130 at an angle therebetween, and an opened side of the upper reflection mirror 162 and the lower reflection mirror 164 may face the side of the housing 130 opened in a C-shape.

Preferably, the angle between the reflection mirrors 160 may be adjustable. That is, the angle between the upper reflection mirror 162 and the lower reflection mirror 164 may be adjusted for proper illumination.

In the above-described structure, light emitted from the LEDs 150 disposed in the housing 130 is directed to the opened side of the housing 130. That is, since the reflection mirrors 160 are disposed at an angle therebetween, light emitted from the LEDs 150 propagates to the opened side of the housing 130 while being repeatedly reflected, and thus an object may be illuminated by the light.

Preferably, as described above, metallic attachment parts 170 corresponding to magnets disposed in a light transmitting member may be disposed on an upper end of the housing 130.

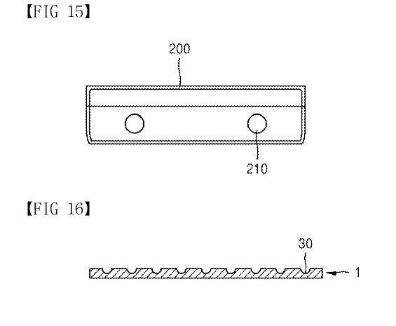

FIG. 15 is a view illustrating a fixing clip 200 of a lighting device according to an aspect of the presently disclosed embodiment.

The fixing clip 200 may grip a side of an object to be illuminated. In this way, the fixing clip 200 may be fixed to the object. For example, the fixing clip 200 may be a clip having a predetermined area. The lighting device may be firmly fixed to an object to be illuminated by connecting the fixing clip 200 and the housing 130.

Preferably, magnetic members may be disposed at corresponding positions of the fixing clip 200 and the housing 130. That is, as shown in FIG. 15, second magnetic members 180 may be disposed on a lower side of the housing 130, and first magnetic members 210 corresponding to the second magnetic members 180 may be disposed on an upper surface of the fixing clip 200 for coupling between the housing 130 and the fixing clip 200. Since the housing 130 and the fixing clip 200 are coupled by the magnetism of the magnetic members, the housing 130 and the fixing clip 200 may easily be coupled and detached.

Power may be transmitted through the fixing clip 200 from an illumination target object to the PCB 140 disposed in the housing 130 of the lighting device. That is, for example, when the fixing clip 200 is used with an e-book terminal, the fixing clip 200 may electrically connected to external power terminals of the e-book terminal, and power may be transmitted to the PCB 140 disposed in the housing 130 for operating the LEDs 150.

In other words, the fixing clip 200 may include electricity connection terminals for transmitting power of an internal power source of an illumination target object to the PCB 140 and the LEDs 150 disposed in the housing 130, and the LEDs 150 disposed in the housing 130 may be configured to use power supplied from the internal power source of the illumination target object.

In a non-limiting example, an electric connection for this may be made by a contact between the magnetic members. That is, an electric connection may be made by a contact between the magnetic members, or electric terminals may be electrically connected when the fixing clip 200 and the housing 130 are connected. However, the aspects of the presently disclosed embodiment are not limited thereto. For this, the housing 130 may include an electric connection part such as a wire 190. However, the aspects of the presently disclosed embodiment are not limited thereto.

In this manner, the lighting device of the presently disclosed embodiment may be operated by power supplied from an internal power source of an illumination target object such as an e-book terminal.

Although preferable aspects have been described with reference to the accompanying drawings, the presently disclosed embodiment is not limited to the aspects. Therefore, it will be readily understood by those of ordinary skill in the art that various modifications and changes can be made thereto without departing from the spirit and scope of the presently disclosed embodiment defined by the appended claims.

What is claimed is:

1. A lighting device comprising:
a light emitting diode (LED) mounted on a substrate;
a light transmitting member disposed above an illumination surface with a minimal gap from the LED; and
a housing in which the substrate, the light transmitting member, and a battery assembly are assembled,
wherein the light transmitting member is formed of a transparent material to transmit light from a light source onto the illumination surface,
the light transmitting member has a generally thin rectangular shape formed by two mutually-facing lateral surfaces, two mutually-facing end surfaces, an upper major surface, and a lower major surface,
one or more of the end surfaces are coated with a reflective material, and one or more of the upper and lower major surfaces have negative curvatures, and
the light transmitting member is disposed along an optical path of the LED to refract light emitted from the LED onto the illumination surface.

2. The lighting device of claim 1, wherein the light transmitting member is bent to enhance illumination of the illumination surface.

3. The lighting device of claim 1, wherein the upper major surface is coupled with a Fresnel lens for optical magnification.

4. The lighting device of claim 1, wherein a transparent film is attached to the upper major surface.

5. The lighting device of claim 1, wherein the light transmitting member comprises a pattern formed by a plurality of fine hemispherical recesses formed in at least a surface portion thereof.

6. The lighting device of claim 1, wherein the housing comprises a jaw bent in a reverse L-shape, and an end of the reverse L-shape is rounded.

7. The lighting device of claim 1, wherein a magnetic member is disposed on a side of the light transmitting member, and
an attachment part corresponding to the magnetic member and magnetically attractable to the magnetic member is disposed on at least a side of an upper end of the housing.

8. The lighting device of claim 1, wherein the housing has a side opened in a C-shape,
a printed circuit board (PCB), the LED mounted on the PCB, and reflection mirrors reflecting light emitted from the LED are disposed in the housing, and
the reflection mirrors are disposed at upper and lower sides in the housing with an angle between the reflection mirrors, and an opened side of the reflection mirrors faces the opened side of the housing to direct light emitted from the LED to the opened side of the housing.

9. The lighting device of claim 1, further comprising a fixing clip gripping a side of an illumination target object,
wherein a first magnetic member is disposed on an upper surface of the fixing clip, and
a second magnetic member corresponding to the first magnetic member and magnetically attractable to the first magnetic member is disposed on a lower surface of the housing.

10. The lighting device of claim 9, wherein the fixing clip comprises an electricity connection terminal to connect an internal power source of the illumination target object to the PCB and the LED disposed in the housing, and the LED disposed in the housing is configured to use the internal power source of the illumination target object as a power source.
